(19) United States
(12) Patent Application Publication
(10) Pub. No.: US 2006/0248588 A1
(43) Pub. Date: Nov. 2, 2006

(54) Defending Denial of Service Attacks in an Inter-networked Environment

(75) Inventor: Kannan Jayaraman, Bangalore (IN)

Correspondence Address: LAW FIRM OF NAREN THAPPETA, C/O LANDON IP, INC., 1700 DIAGONAL ROAD, SUITE 450, ALEXANDRIA, VA, 22314, US

(73) Assignee: NETDEVICES, INC., Sunnyvale (US)

(21) Appl. No.: 11/160,285

(22) Filed: Jun. 17, 2005

(30) Foreign Application Priority Data
Apr. 28, 2005 (IN) 504/CHE/2005

(51) Int. Cl. G06F 12/14

(52) U.S. Cl. 726/22

(57) ABSTRACT

According to an aspect of the present invention, routers are notified of occurrence of denial of service (DoS) attack. The DoS attack can be within another router or other user systems contained in an inter-networked environment. The routers may perform actions such as throttling/blocking packets which would continue to cause such DoS attack. Multiple routers may collaboratively mitigate the effect of the DoS attack.

### BACKGROUND OF THE INVENTION

1. Field of the Invention

The present invention relates generally to router devices used in communication networks, and more specifically to a method and apparatus for defending denial of service (DoS) attacks in an inter-networked environment.

2. Related Art

An inter-networked environment generally refers to a conglomeration of independent networks. Typically, each network contains multiple end systems, and the networks are connected by routers, which operate using the Internet protocol (IP). For example, in one common scenario, a customer premise equipment (CPE) and a service-provider equipment (SPE) are respectively provided at the edges of enterprise and internet service provider (ISP) networks. The enterprise network contains several user systems which access various servers and services available on the Internet via CPE, SPE and Internet, as is well known in the relevant arts.

Denial of service (DoS) attacks are often of concern in inter-networked environments. A DoS attack generally floods a target device (end system or routers) with malicious packets which consume various resources (processing, memory/buffer, etc.) on the target device, thereby rendering the target device at least unable to process packets at full potential. Often, the capacity of the target device to process valid user packets is substantially diminished, and it is therefore desirable to ‘defend’ (somehow avoid/mitigate the attacks, or the effects thereof) against such DoS attacks.

What is therefore needed is a method and apparatus for defending denial of service (DoS) attacks in an inter-networked environment.

### BRIEF DESCRIPTION OF THE DRAWINGS

The present invention will be described with reference to the accompanying drawings, which are described below briefly. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an example inter-networking environment in which various aspect of the present invention can be implemented.

FIG. 2 is a flow chart illustrating the manner in which a system operates to defend against DoS attacks in an embodiment of the present invention.

FIG. 3 is a flow chart illustrating the manner in which routers in operate to defend a DoS attack in an embodiment of the present invention.

FIG. 4 is an example packet format used for notification of a DoS attack in an embodiment.

FIG. 5 is a block diagram illustrating the details of implementation of a CPE equipment in an embodiment of the present invention.

FIG. 6 is a block diagram illustrating the details of implementation of a router in an embodiment of the present invention.

FIG. 7 is a block diagram illustrating the details of an embodiment of a digital processing system where various aspects of the present invention are operative by execution of appropriate software instructions.

### DETAILED DESCRIPTION OF THE PREFERRED EMBODIMENTS

1. Overview and Discussion of the Invention

A system provided according to an aspect of the present invention detects the occurrence of a denial of service (DoS) attack, and notifies other routers in the inter-networked environment of the attack. The notification enables various routers in the inter-networked environment to collaboratively defend against the DoS attack. For example, the notified routers may block at least some of the packets causing (otherwise ongoing) the DoS attack. The device may send additional information, as relevant to the specific DoS attack, to enable the routers to effectively defend against the attack.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well_known structures or operations are not shown in detail to avoid obscuring the features of the invention.

2. Example Environment

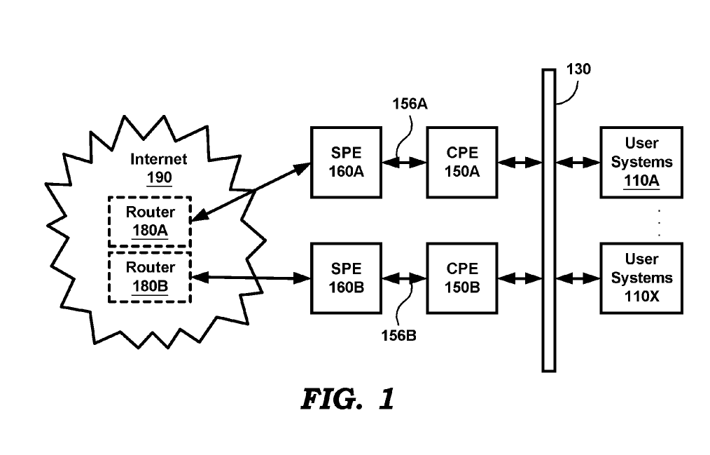

FIG. 1 is a block diagram illustrating the details of an example internetworking environment in which various aspects of the present invention can be implemented. The environment is shown containing user systems 110A-110X, local-area-network (LAN) 130, customer premise equipments (CPEs) 150A and 150B, service provider equipments (SPEs) 160A and 160B, routers 180A-180C, and Internet 190.

User systems 110A-110X, LAN 130 and CPE 150 may be physically located on the customer premises (e.g., part of an enterprise), while SPE 160 may be located on the premises of an Internet Service Provider (ISP). Routers 180A-180C are shown contained in Internet 190. Each component of FIG. 1 is described below in further detail.

User systems 110A-110X are connected to LAN 130. LAN 130 may be implemented using protocols such as Ethernet 802.3 and user systems 110A-110X communicate with each other and to systems accessible by Internet 190 using Internet Protocol (IP) on Ethernet 802.3. User systems and LAN can be implemented using other protocols and media access control, without departing from various aspects of the present invention, as will be apparent to one skilled in the relevant arts by reading the disclosure provided herein.

CPE 150A and SPE 160A are implemented with compatible interface on path 156A, and correspond to IP routers. Path 156A may be implemented using a leased line (e.g., T1/T3) or using technologies such as digital subscriber loop (DSL), well known in the relevant arts. The use/operation of CPE 150B, 160B and path 156B is similarly described and is not repeated in the interest of conciseness. By operating as IP routers, CPEs 150A and 150B, and SPEs 160A and 160B enable user systems 110A-110X to access various services and systems accessible via Internet 190 (shown containing IP routers 180A and 180B).

Of concern often is denial of service (DoS) attacks on various systems (CPEs and user systems) located on the customer premises. The manner in which the DoS attacks can be defended according to various aspects of the present invention is described below in further detail below.

3. Defending DoS Attacks

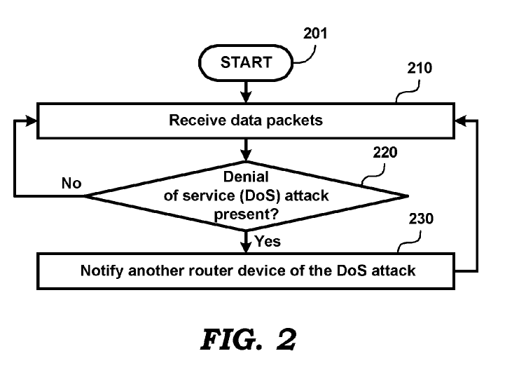

FIG. 2 is a flowchart illustrating the manner in which DoS attacks can be defended according to an aspect of the present invention. The description is provided with respect to FIG. 1 merely for illustration. However, the flowchart can be implemented in other systems and environments, without departing from the scope and spirit of various aspects of the present invention. The flowchart begins in step 201, in which control passes to step 210.

In step 210, CPE 150A receives data packets. In step 220, CPE 150A determines whether the received data packets indicate a denial of service (DoS) attack. Various approaches well known in the relevant arts can be used in detecting the DoS attack. However, in general, the determination is based on factors such as frequency of occurrence of a specific type of packets, the resources being consumed due to a type of packets, etc. The manner in which DoS attack can be determined in an example scenario (TCP SYN), is described in sections below. Control passes to step 230 if a DoS attack is deemed to have occurred and to step 210 otherwise.

In step 230, CPE 150A notifies other router device(s) of the DoS attack, along with the related information. In an embodiment, all the adjacent routers (CPE 150B, SPEs 160A and 160B) are notified of the attack. Either unicast packets (i.e., destination address of each packet equaling the IP address of the corresponding router sought to be notified) or multicast/broadcast packets can be used for the notification.

The specific information sent depends on the attack type, as well as the manner in which the information can be used by the router devices in defending the attack. The specific information sent in response to a TCP SYN attack is described in sections below. The flowchart ends in step 299.

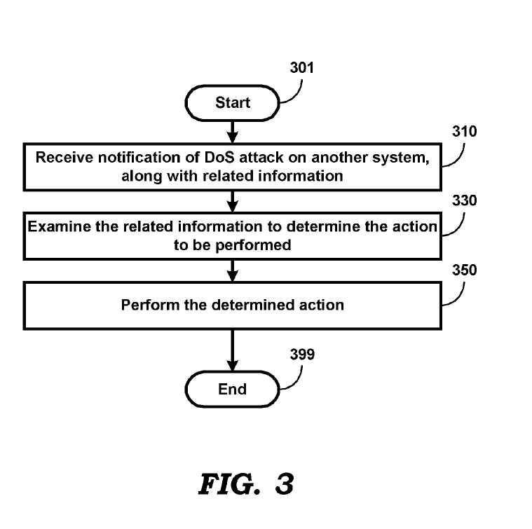

As noted above, other routers may collaborate in defending against DoS attacks. For illustration it is assumed that the notification of step 230 is sent to SPE 160A. The manner in which SPE 160A may operate in response, is described below with reference to FIG. 3.

4. Collaborative Defense

FIG. 3 is a flowchart illustrating the manner in which routers collaborate to defend against DoS attacks according to an aspect of the present invention. The description is provided with respect to SPE 160A of FIG. 1 merely for illustration. However, the flowchart can be implemented in other systems and environments, without departing from the scope and spirit of various aspects of the present invention. The flowchart begins in step 301, in which control passes to step 310.

In step 310, SPE 160A receives notification (either by unicast or broadcast packets) of DoS attack detected by another system (CPE 150A in the illustrative example), along with the related information. As noted above, the related information may contain data needed for the actions to be performed corresponding to the DoS attack type, and is described in further detail below for an example scenario (TCP SYN attack).

In step 330, SPE 160A examines the related information to determine the action to be performed. The action depends on the specific DoS attack type and the information available in the specific instance. In step 350, SPE 160A performs the determined action. In an embodiment, the determined action corresponds to either blocking at least some of the packets causing the DoS attack, forwarding the notification to other routers and/or causing configuration of another system to defend against the DoS attack. The flowchart ends in step 399.

Due to the operation in accordance with FIGS. 2 and 3, DoS attacks may be defended by collaborative actions of several routers according to several features of the present invention. The features described above are illustrated in further detail with respect TCP SYN attack.

5. TCP SYN Attack

A brief description of TCP SYN attack is provided first. TCP SYN attack can be appreciated by understanding the manner in which a TCP connection is typically established between two end systems. The first end system sends a TCP connection establishment packet on a known destination port to the second end system. The second end system sends back a reply packet (SYN-ACK) to the first end system (using the source IP address in the connection establishment packet), potentially confirming the port on which communication will be received for this TCP connection.

The second system waits for an acknowledgment (ACK), and allocates resources such as table entries and buffer space for the pending TCP connection. Once the ACK is received, the TCP connection setup is said to be complete. Further details on TCP connection establishment are provided in RFC 793 entitled, “Transmission Control Protocol—DARPA Internet Program: Protocol Specification” dated September 1981.

In the case of SYN attack, a malicious end system floods the second end system (victim) with TCP connection establishment packets with a spoof (non-existent machine) IP address. As a result, the second end system sends a reply packet, but does not receive the corresponding ACK (or TCP connection termination packet). Accordingly, resources would continue to be allocated due to the malicious packets received from the malicious end system, and the second end system is said to have experienced a TCP SYN DoS attack.

Continuing with the description of the steps of FIG. 2 with respect to SYN attack, the manner in which CPE 150A can determine the occurrence of a SYN attack (step 220) is described first. It should be first noted that the victim of a SYN attack can be CPE 150A or user systems (say 110A).

In case the victim of the SYN attack is CPE 150A, the attack can be detected based on the rate at which the TCP SYN packets arrive per second. This can be a primary measure. The detection can also be based on the number of TCP connections waiting for the ACK packet, the duration of the wait, the IP address of the other end of the TCP connection causing the TCP connections, etc. Accordingly, CPE 150A needs to be designed to maintain the necessary detailed information and examine the internal structures to determine whether CPE 150A itself is subject to SYN attack.

In case the victim of the SYN attack is user system 110A, user system 110A may be designed to examine internal structures as noted above and communicate the same to CPE 150A. Alternatively, CPE 150A may be designed to keep track of the status of TCP connections sought to be established to each user system.

In such a case, CPE 150A maintains an internal table which indicates the status of TCP connections based on contents of the corresponding IP packets. In general, the payload of the IP packet needs to be parsed to interpret whether the packet relates to connection setup, and the determined information is placed in the internal table. The contents of the internal table would then need to be examined similar to as in the case of user system 110A is a victim.

Such a feature could automatically be provided in embodiments in which firewall features are integrated into CPE 150A. In general, in such embodiments, it is assumed that CPE 150A would be in the path of both directions of packets being exchanged for TCP connection establishment, and would be typically true when CPE 150A acts as a gateway to the external networks.

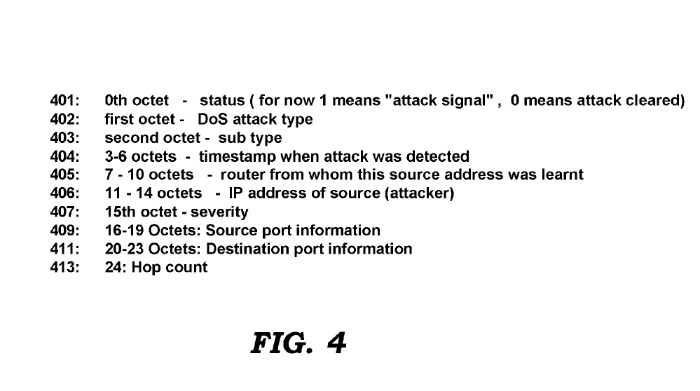

Continuing with respect to notification of step 230, a suitable packet format and protocol need to be employed for such notification. An example packet format is described in sections below with respect to FIG. 4. The content of the packet will also be clear from the description below.

With respect to actions (of steps 330 and 350) in the case of SYN attacks, as noted above, the packets which would cause ongoing attack can be blocked. Accordingly, the information necessary for identifying such packets (e.g., the IP address(es) used as the source address of the malicious packets and the port number, or in general flow(s)) needs to be contained along with the notification. SPE 160A may perform additional actions such as notifying administrator of the ISP, or passing the notification to security device specifically deployed to counter DoS attackes.

In one embodiment, all the malicious packets are blocked only if the SYN attack is extremely severe (e.g., the number of open connections exceeding a corresponding threshold), and some of the packets (which would cause SYN attack) may be continued (i.e., the connection is throttled) to be forwarded if the attack is less severe. Accordingly, the packet format (for notification) may need to provide for the severity of the DoS attack as well. An example packet format meeting such requirements for DoS notification is described below.

6. Packet/Protocol for DoS Notification

In an embodiment, ICMP protocol is extended to send the notification since routers not implementing the extensions would be designed to ignore the corresponding ICMP packets. ICMP packet format and the manner in which the protocol can be extended, is described in further detail in RFC 792, entitled, “Internet Control Message Protocol: DARPA Internet Program”, available from www.ietf.org. Assuming a type field (byte number 13) is determined for the extension, the remaining packet format is depicted (with a offset of 0 bytes) in FIG. 4, and is described below.

The 0th octet contains a status indicating whether the DoS attack is on-going (value of 1) or has cleared (0). The first octet is then used to specify the DoS attack type (e.g., a value of 1 indicates that the type is of flooding type), the second octet indicates any applicable sub-type of the DoS attack. For SYN attacks, the value of the second octet is set to

Octets 3_6 contain a timestamp when the packet was generated (or when the status was detected). Octets 7-10 indicate the first hop router (from CPE 150A) when sending the packets to the attacker. Octets 11-14 contain the IP address of the attacker. Octet 15 indicates the severity level of the attack (as noted above, depending on the severity level, the packet discarding/blocking can be handled differently).

Octets 16-17 contain the source port number and octets 18-19 for a corresponding mask (to be able to indicate a range of port numbers). Octets 20-23 may similarly contain the information for the destination port number used for DoS attack.

Octet 24 includes a hop count indicating the number of routers through which the packet has been processed collaboratively. Thus, when CPE 150A creates and sends the packet, the hop count is set to 0 and each subsequent router processing the packet increments the hop count by 1. At some pre-specified hop count, further forwarding of the packet may be avoided.

It should be appreciated that proper authentication mechanisms also need to be incorporated to ensure that SPE 160A (or other routers) would only act in response to valid DoS attack detections. The packet formats may be extended for such authentication as well. Thus, the information in the packet format would authenticate CPE 150A when CPE 150A notifies SPE 160A of a DoS attack.

Various embodiment of CPE 150A and SPE 160A (router) can be implemented using packet formats and protocols, such as those described above. The description is continued with respect to details of example embodiments of CPE 150A and SPE 160A.

7. CPE Implementation

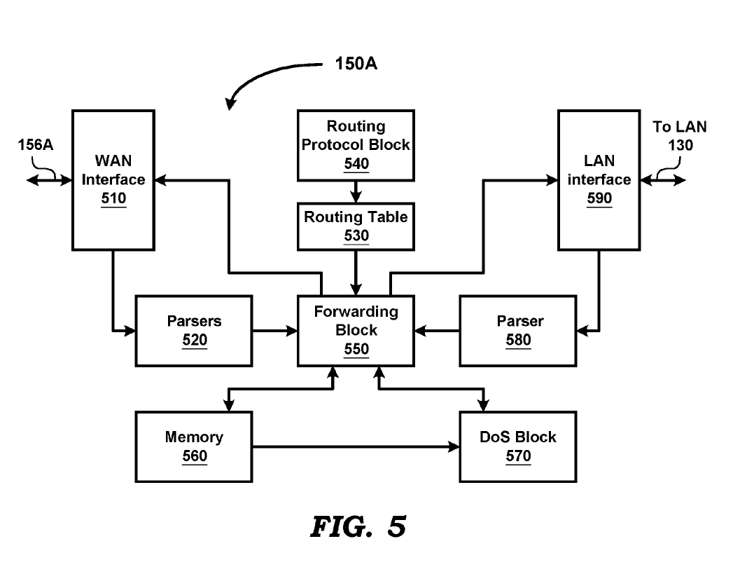

FIG. 5 is a block diagram illustrating the details of implementation of CPE 150A in an embodiment of the present invention. CPE 150A is shown containing WAN (wide-area network) interface 510, parsers 520 and 580, routing table 530, routing protocol block 540, forwarding block 550, memory 560, DoS Block 570 and LAN interface 590. Each block is described below in further detail.

WAN interface 510 provides the physical, electrical and protocol (media access and transmission) support to transmit/receive packets on/from path 156A. The received packets are forwarded to parser block 520. LAN interface 590 similarly provides the physical, electrical and protocol support to transmit/receive packets to/from LAN 130. The received packets are forwarded to parser block 580.

Parser block 520 examines the packets received from WAN interface 510 to determine the specific block to which each packet is to be forwarded. Packets related to routing protocols are forwarded to routing protocol block 540, and the remaining packets are forwarded to forwarding block 550. The operation of parser block 580 is also similar described, except that packets received from LAN 130 are examined.

Routing protocol block 540 processes the packets related to routing protocols, and updates the routing tables contained in routing table 530. Routing protocol block 540 can be implemented in a known way. In general, the routing tables specify the interface/line on which each packet needs to be forwarded, and is typically determined based on the destination address of the packet.

Forwarding block 550 forwards each received packet according to the routing table entries in routing table 530. The destination address of each packet is compared against the entries in the routing tables, and a determination is made as to the manner in which to forward the packet. Forwarding block 550 may perform other operations as relevant to defending against DoS attacks, as described in further detail below.

DoS block 570 operates to detect DoS attacks and form packets to notify other routers of the attack. In the case of DoS attacks directed to CPE 150A itself, various internal data structures (including counters) may be examined to determine the occurrence of the attack, as described above with respect to TCP SYN attack. The data structures may be present in memory 560.

With respect to determining DoS attacks on user systems behind CPE 150A (i.e., those connected on LAN 130), DoS block 570 may receive the header of each packet forwarded by forwarding block 550, and maintain various required status information (in memory 560). The status information can contain various counters (e.g., number of packets originating from a particular source) of interest, etc. In the case of TCP SYN attacks, DoS block 570 maintains the status of various TCP connections (based on packets being forwarded in both directions).

Once a DoS attack is detected, DoS block 570 forms a packet (e.g., according to the format of FIG. 4) representing a notification, and operates in conjunction with forwarding block 550 to cause the packet to be forwarded to SPE 160A (to notify other routers in the path to the attacker causing DoS). DoS block 570 may, in addition, cause (self) configuration (e.g., cause forwarding block 550 to block packets) of CPE 150A to defend against the DoS attacks.

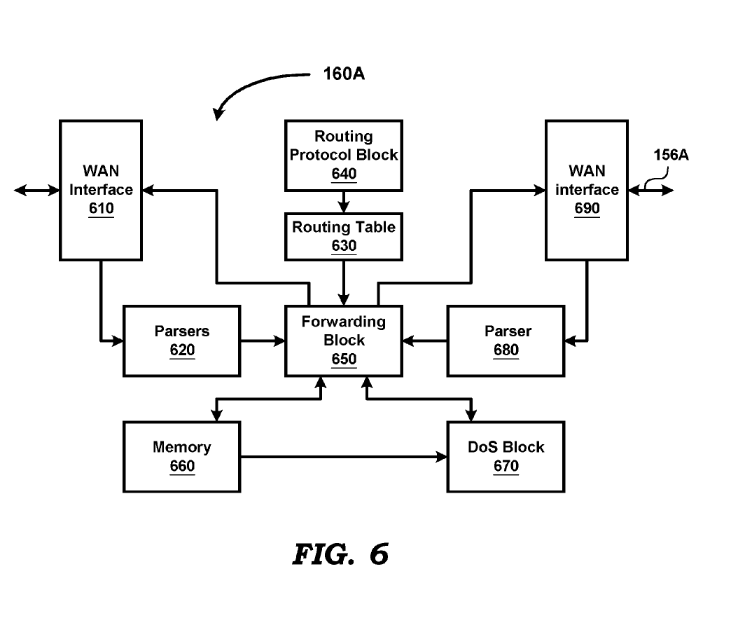

SPE 160A needs to perform actions to at least mitigate the effects of the DoS attack notified in the packets. The description is continued with respect to the details of an embodiment of SPE 160A, which performs such actions, as described below with respect to FIG. 6.

8. SPE Implementation

FIG. 6 is a block diagram illustrating the details of SPE 160A in one embodiment. SPE 160A is shown containing WAN interfaces 610 and 690, parsers 620 and 680, routing table 630, routing protocol block 640, forwarding block 650, memory 660, and DoS Block 670. The blocks are described below in comparison with the corresponding blocks of FIG. 5 for conciseness.

Interfaces 610 and 690, parsers 620 and 680, routing table 630, routing protocol block 640, forwarding block 650, and memory 660 respectively operate similar to interfaces 510 and 590, parsers 520 and 580, routing table 530, routing protocol block 540, forwarding block 550, and memory 560, and the description is not repeated for conciseness.

DoS block 670 receives notification of DoS attacks, and processes each notification depending on the attack type. DoS block 670 may forward the notification to additional routers if the hop count in the packet is below a pre-specified threshold. The hop count may be incremented before forwarding the packet to such additional routers. In addition, DoS block 670 operates cooperatively with forwarding block 650 to block one or more packets causing the DoS attack. Also, DoS block 670 may configure other systems (not shown), which would defend against the DoS attack.

Thus, by using the collaborative features described above, the embodiments of FIGS. 5 and 6 can be used to defend against denial of service (DoS) attacks. It should be understood that the different blocks of the systems there can be implemented in a combination of one or more of hardware, software and firmware. In general, when throughput performance is of primary consideration, the implementation is performed more in hardware (e.g., in the form of an application specific integrated circuit).

When cost is of primary consideration, the implementation is performed more in software (e.g., using a processor executing instructions provided in software/firmware). Cost and performance can be balanced by implementing CPE 150A and SPE 160A with a desired mix of hardware, software and/or firmware. The description is continued with respect to embodiments in which various features of the present invention are operative by execution of appropriate software instructions, as described below.

9. Software Implementation

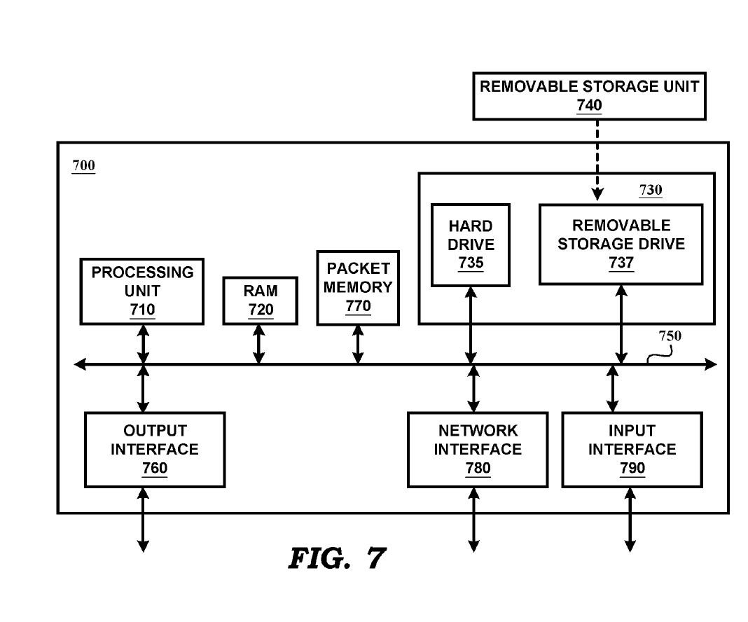

FIG. 7 is a block diagram illustrating the details of digital processing system 700 in one embodiment. System 700 can correspond to one of CPE 150A, SPE 160A or other systems in which various aspects of the present invention can be implemented. System 700 is shown containing processing unit 710, random access memory (RAM) 720, secondary memory 730, output interface 760, packet memory 770, network interface 780 and input interface 790. Each component is described in further detail below.

Input interface 790 (e.g., interface with a key_board and/or mouse, not shown) enables a user/administrator to provide any necessary inputs to system 700. Output interface 760 provides output signals (e.g., display signals to a display unit, not shown), and the two interfaces together can form the basis for a suitable user interface for an administrator to interact with system 700.

Network interface 780 may enable system 700 to send/receive data packets to/from other systems on corresponding paths using protocols such as internet protocol (IP). Network interface 780, output interface 760 and input interface 790 can be implemented in a known way.

RAM 720 (supporting memory 560), secondary memory 730, and packet memory 770 may together be referred to as a memory. RAM 720 receives instructions and data on path 750 (which may represent several buses) from secondary memory 730, and provides the instructions to processing unit 710 for execution. In addition, the variables and counters described above may be maintained in the memory.

Packet memory 770 stores (queues) packets waiting to be forwarded (or otherwise processed) on different ports/interfaces. Secondary memory 730 may contain units such as hard drive 735 and removable storage drive 737. Secondary memory 730 may store the software instructions and data, which enable system 700 to provide several features in accordance with the present invention.

Some or all of the data and instructions may be provided on removable storage unit 740 (or from a network using protocols such as Internet Protocol), and the data and instructions may be read and provided by removable storage drive 737 to processing unit 710. Floppy drive, magnetic tape drive, CD_ROM drive, DVD Drive, Flash memory, removable memory chip (PCMCIA Card, EPROM) are examples of such removable storage drive 737.

Processing unit 710 may contain one or more processors. Some of the processors can be general purpose processors which execute instructions provided from RAM 720. Some can be special purpose processors adapted for specific tasks (e.g., for memory/queue management). The special purpose processors may also be provided instructions from RAM 720.

In general, processing unit 710 reads sequences of instructions from various types of memory medium (including RAM 720, storage 730 and removable storage unit 740), and executes the instructions to provide various features of the present invention described above.

10. Conclusion While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of defending denial of service (DoS) attacks in an inter-networked environment, said method being performed in a first system, said method comprising:
detecting the occurrence of a denial of service (DoS) attack; and
notifying a router contained in said inter-networked environment of said DoS attack.

2. The method of claim 1, wherein said notifying is performed by sending one or more packets, wherein said one or more packets include data identifying a source machine causing said DoS attack.

3. The method of claim 2, wherein said first system itself is subjected to said DoS attack, and wherein said detecting examines data structures in said first system to determine that said first system is subjected to said DoS attack.

4. The method of claim 2, wherein a second system in said inter-networked environment is subjected to said DoS attack, wherein said first system is physically separate from said second system.

5. The method of claim 4, wherein said detecting comprises examining packets forwarded to and received from said second system.

6. The method of claim 5, wherein said DoS attack comprises a TCP SYN attack.

7. The method of claim 2, wherein said one or more packets are sent according to a format, wherein said format includes a first field to specify a type of said DoS attack and a second field to specify an IP address of said source machine.

8. The method of claim 2, wherein the destination address of each of said one or more packets equals an address of said router.

9. The method of claim 1, wherein said first system comprises a customer premise equipment (CPE).

10. A method of defending denial of service (DoS) attacks in an inter-networked environment, said method being performed in a router, said method comprising:
receiving a notification indicating the occurrence of a denial of service (DoS) attack in another system; and
performing an action to at least mitigate an effect of said DoS attack on said another system, wherein said another system is physically separate from said router.

11. The method of claim 10, wherein said action comprises blocking a packet from a source machine causing said DoS attack.

12. A computer readable medium carrying one or more sequences of instructions causing a first system to defend denial of service (DoS) attacks in an inter-networked environment, wherein execution of said one or more sequences of instructions by one or more processors contained in said first system causes said one or more processors to perform the actions of:
detecting the occurrence of a denial of service (DoS) attack; and
notifying a router contained in said inter-networked environment of said DoS attack.

13. The computer readable medium of claim 12, wherein said notifying is performed by sending one or more packets, wherein said one or more packets include data identifying a source machine causing said DoS attack.

14. The computer readable medium of claim 13, wherein said first system itself is subjected to said DoS attack, and wherein said detecting examines data structures in said first system to determine that said first system is subjected to said DoS attack.

15. The computer readable medium of claim 13, wherein a second system in said inter-networked environment is subjected to said DoS attack, wherein said first system is physically separate from said second system.

16. The computer readable medium of claim 15, wherein said detecting comprises examining packets forwarded to and received from said second system.

17. The computer readable medium of claim 16, wherein said DoS attack comprises a TCP SYN attack.

18. The computer readable medium of claim 13, wherein said one or more packets are sent according to a format, wherein said format includes a first field to specify a type of said DoS attack and a second field to specify an IP address of said source machine.

19. The computer readable medium of claim 13, wherein the destination address of each of said one or more packets equals an address of said router.

20. The computer readable medium of claim 12, wherein said first system comprises a customer premise equipment (CPE).
